(19) United States
(12) Patent Application Publication
(10) Pub. No.: US 2024/0062048 A1
(43) Pub. Date: Feb. 22, 2024

(54) LEARNING DEVICE, LEARNING METHOD, AND STORAGE MEDIUM

(71) Applicant: NEC Corporation, Minato-ku, Tokyo (JP)

(72) Inventor: Ryosuke SAKAI, Tokyo (JP)

(73) Assignee: NEC Corporation, Minato-ku, Tokyo (JP)

(21) Appl. No.: 18/269,790

(22) PCT Filed: Dec. 28, 2020
(86) PCT No.: PCT/JP2020/049146

§ 371 Date: Jun. 27, 2023

(51) Int. Cl. G06N 3/047; G06N 3/084

(52) U.S. Cl. CPC G06N 3/047; G06N 3/084

(57) ABSTRACT

A learning device 1X includes a probabilistic inference result generation means 16X, a formatting means 17X, and a training means 18X. The probabilistic inference result generation means 16X is configured to generate a probabilistic inference result that is probabilistically generated for an input data. The formatting means 17X is configured to generate a formatted inference result obtained by formatting the probabilistic inference result. The training means 18X is configured to train a correction learning model that is a learning model configured to correct the formatted inference result, based on the input data, correct answer data corresponding to the input data, and the formatted inference result.

### TECHNICAL FIELD

The present disclosure relates to a technical field of a learning device, a learning method, and a storage medium for model learning.

### BACKGROUND ART

Patent Literature 1 discloses an example of a method of extracting feature points from an image. Patent Literature 1 discloses an object recognition device configured to generate deterioration data having a missing feature point from correct answer data and train a complement engine for compensating for the missing feature point based on the original image and the deterioration data.

### CITATION LIST

### Patent Literature

Patent Literature 1: JP 2020-123105A

### SUMMARY

### Problem to be Solved

The method according to Patent Literature 1 is specialized in such an issue that hidden feature points are likely to be missed, and therefore it is intended to be applied only when the cause of the current accuracy deterioration is apparent. On the other hand, since the cause of accuracy deterioration is various, it is desirable to be able to perform high accuracy inference without depending on the cause of accuracy deterioration.

In view of the above-described issue, it is therefore an example object of the present disclosure to provide a learning device, a learning method, and a storage medium capable of suitably perform model learning to realize an inference with a high degree of accuracy.

### Means for Solving the Problem

In one mode of the learning device, there is provided a learning device including:
a probabilistic inference result generation means configured to generate a probabilistic inference result that is probabilistically generated for an input data;
a formatting means configured to generate a formatted inference result obtained by formatting the probabilistic inference result; and
a training means configured to train a correction learning model that is a learning model configured to correct the formatted inference result, based on the input data, correct answer data corresponding to the input data, and the formatted inference result.

In one mode of the learning method, there is provided a learning method executed by a computer, the learning method including:
generating a probabilistic inference result that is probabilistically generated for an input data;
generating a formatted inference result obtained by formatting the probabilistic inference result; and
training a correction learning model that is a learning model configured to correct the formatted inference result, based on the input data, correct answer data corresponding to the input data, and the formatted inference result.

In one mode of the storage medium, there is provided a storage medium storing a program executed by a computer, the program causing the computer to:
generate a probabilistic inference result that is probabilistically generated for an input data;
generate a formatted inference result obtained by formatting the probabilistic inference result; and
train a correction learning model that is a learning model configured to correct the formatted inference result, based on the input data, correct answer data corresponding to the input data, and the formatted inference result.

### Effect

An example advantage according to the present invention is to suitably perform the training of a correction learning model to realize an inference with a high degree of accuracy.

### BRIEF DESCRIPTION OF THE DRAWINGS

FIG. 1 It illustrates a schematic configuration of a learning system in the first example embodiment.

FIG. 2 It illustrates an example of a hardware configuration of a learning device.

FIG. 3 It is a schematic diagram showing an outline of a learning process.

FIG. 4A illustrates a first example of applying a dropout to a already-trained model, which is a neural network.

FIG. 4B illustrates a second example of applying a dropout to a already-trained model, which is a neural network.

FIG. 5 It is an example of a functional block diagram of a learning process in the first example embodiment.

FIG. 6A illustrates a structure of a correction learning model with a clear indication of a layer thereof to which an input image and a formatted inference result are inputted in common when the input image and the formatted inference result are inputted to a single layer.

FIG. 6B illustrates a structure of a correction learning model with a clear indication of its layers thereof to which an input image and a formatted inference result are separately inputted when the input image and the formatted inference result are separately inputted to different layers.

FIG. 7 It illustrates an example of a flowchart showing a procedure of the learning process.

FIG. 8A is a diagram showing a label of each feature point when thirteen feature points of a tennis court are labeled by separate name definition with reference to a certain viewpoint.

FIG. 8B is a diagram showing a label of each feature point when thirteen feature points of a tennis court are labeled by separate name definition with reference to another viewpoint.

FIG. 9 It is a diagram showing a label of each feature point when thirteen feature points of a tennis court are labeled by same name definition with reference to a certain viewpoint.

FIG. 10 It is a schematic diagram of a process according to the second example embodiment.

FIG. 11 It is a block diagram of a learning device in the third example embodiment.

FIG. 12 It is an example of a flowchart in the third example embodiment.

### EXAMPLE EMBODIMENTS

Hereinafter, example embodiments of a learning device, a learning method, and a storage medium will be described with reference to the drawings.

### First Example Embodiment

(1) Overall Configuration

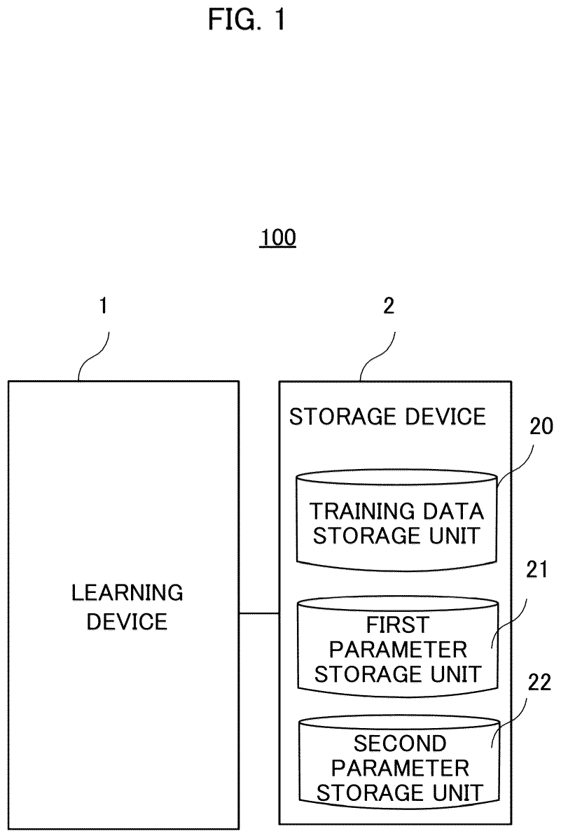

FIG. 1 shows a schematic configuration of a learning system 100 according to the first example embodiment. The learning system 100 performs learning for the purpose of reinforcement (increase in accuracy) of an existing learning model. The learning system 100 includes a learning device 1 and a storage device 2.

Based on information stored in the storage device 2, the learning device 1 performs training of a model (also referred to as “correction learning model”) configured to correct an inference result outputted by an inference model (also referred to as “already-trained model”) which has already been trained. The already-trained model and the correction learning model are, for example, models based on Deep Neural Network (DNN: Deep Neural Network). The already-trained model may be a model configured to output any type of an inference result based on an input image. For example, the already-trained model may be a model configured to output an inference result regarding one or more feature points for the input image or a model configured to output an inference result regarding a segmentation area of an object for the input image. In yet another example, the already-trained model may be a model configured to output an inference result regarding classification for an input image or an object in an input image, or may be a model configured to output an inference result regarding object detection present in the input image. In the present example embodiment, as a representative example, the description will be mainly given of the training of the correction learning model relating to the feature point extraction.

The storage device 2 is one or more memories for storing various information necessary for learning by the learning device 1. The storage device 2 may be an external storage device such as a hard disk connected or embedded in the learning device 1, or may be a storage medium such as a flash memory. The storage device 2 may be a server device that performs data communication with the learning device 1. Further, the storage device 2 may be configured by a plurality of devices. The storage device 2 functionally includes a training data storage unit 20, a first parameter storage unit 21, and a second parameter storage unit 22.

The training data storage unit 20 stores training data to be used for training of a correction learning model to be executed by the learning device 1. The training data includes a plurality of sets of an image (also referred to as “input image”) to be inputted to the correction learning model in the training of the correction learning model and correct answer data that represents a correct answer to be inferred based on the input image. For example, when the already-trained model and the correction learning model are models relating to feature point extraction, the correct answer data includes, for example, information regarding a coordinate value (correct answer coordinate value) of each feature point in the input image to be the correct answer and identification information of the feature point. The “coordinate value” may be a value specifying the position of a specific pixel in the image, or may be a value specifying the position in the image in sub-pixel units. The correct answer data may include information regarding the reliability map (heat map) for each feature point to be extracted, instead of the correct answer coordinate value.

The training data stored in the training data storage unit 20 may be data that is not used for the training of the already-trained model, or may be data that is used for the training of the already-trained model. In the latter case, as will be described later, the learning device 1 generates variations of the training data by performing data extension (data augmentation) that is not executed at the time of training of the already-trained model, and performs training of the correction learning model using the variations of the generated training data.

The first parameter storage unit 21 stores the parameters necessary for building (configuring) the already-trained model. Examples of the parameters described above include parameters regarding the layer structure of the neural network employed in the already-trained model, parameters regarding the neuron structure of each layer, the number of filters and filter size in each layer, and the weight for each element of each filter.

The second parameter storage unit 22 stores the parameters necessary for building the correction learning model. The parameters stored in the second parameter storage unit 22 is updated by the learning device 1 through training of the correction learning model using the training data stored in the training data storage unit 20. In the second parameter storage unit 22, for example, the initial values of the parameters to be applied to the correction learning model are stored, and the above-described parameters are updated every time the training is performed by the learning device 1.

(2) Hardware Configuration

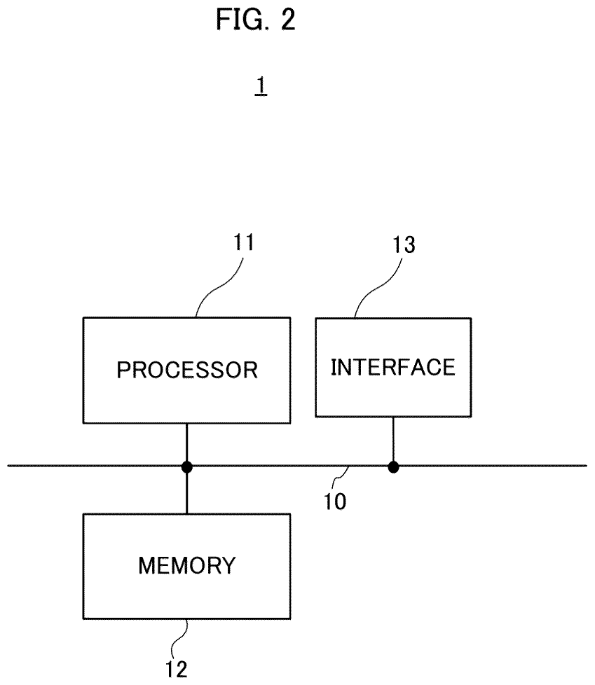

FIG. 2 shows an example of a hardware configuration of the learning device 1. The learning device 1 includes a processor 11, a memory 12, and an interface 13 as hardware. The processor 11, memory 12 and interface 13 are connected to one another via a data bus 10.

The processor 11 executes a predetermined process by executing a program or the like stored in the memory 12. The processor 11 is one or more processors such as a CPU (Central Processing Unit), a GPU (Graphics Processing Unit), and a TPU (Tensor Processing Unit). The processor 11 may be configured by a plurality of processors. The processor 11 is an example of a computer.

The memory 12 is configured by various volatile memories used as working memories and non-volatile memories for storing information needed for the processing by the learning device 1, such as a RAM (Random Access Memory) and a ROM (Read Only Memory). The memory 12 may include an external storage device, such as a hard disk, that is connected or embedded in the learning device 1, or may include a storage medium, such as a removable flash memory. The memory 12 stores a program for the learning device 1 to execute each process according to the present example embodiment. The memory 12 may function as the storage device 2 or a part of the storage device 2 to store at least one of the training data storage unit 20, the first parameter storage unit 21, and the second parameter storage unit 22.

The interface 13 is one or more interfaces for electrically connecting the learning device 1 to other devices. Examples of these interfaces include a wireless interface, such as a network adapter, for transmitting and receiving data to and from other devices wirelessly, and a hardware interface, such as a cable, for connecting to other devices.

The hardware configuration of the learning device 1 is not limited to the configuration shown in FIG. 2. For example, the learning device 1 may further include an input unit for receiving a user input, an output unit such as a display and a speaker.

(3) Learning Process

Next, the details of the learning process executed by the learning device 1 will be described.

(3-1) Outline

Schematically, the learning device 1 trains the correction learning model based on the inference result of the already-trained model that is operated to generate a probabilistic inference is result. Thus, the learning device 1 automatically generates data necessary for training of the correction learning model and suitably executes training of the correction learning model.

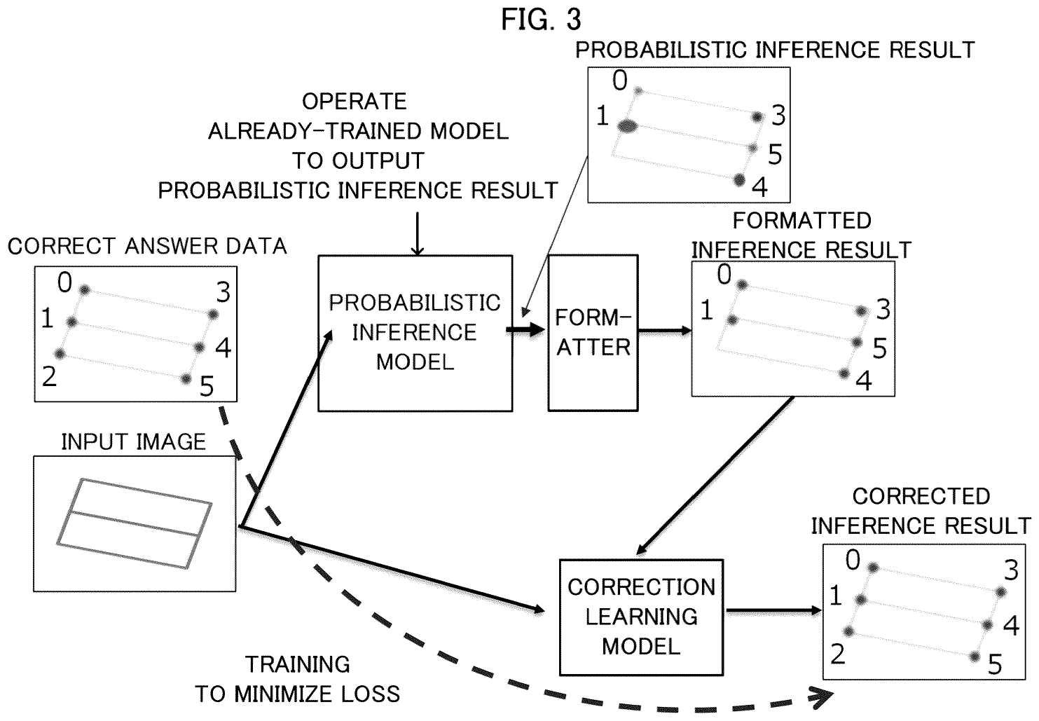

FIG. 3 is a schematic diagram illustrating an outline of a learning process that is executed by the learning device 1. FIG. 3 shows an outline of the learning process in the case where extraction of the feature points (six points with the identification numbers 0 to 5) of a target object of recognition is performed as a representative example.

First, the learning device 1 applies an operation to the already-trained model, which is configured by referring to the first parameter storage unit 21, to output a probabilistic inference result. For example, the learning device 1 probabilistically changes parameters of the already-trained model. As such a technique for probabilistically changing parameters, there is a dropout, which is a process for probabilistically setting one or more weight parameters of the neural network to 0, for example. In this way, it is possible to obtain a variation of the inference result even when the same input is made to the already-trained model. Hereafter, an already-trained model that is operated to output a probabilistic inference result is also referred to as “probabilistic inference model.”

Then, the learning device 1 acquires an inference result (also referred to as “probabilistic inference result”) outputted by the probabilistic inference model by inputting the input image extracted from the training data storage unit 20 into the probabilistic inference model. The learning device 1 may input an image generated by performing data augmentation to the input image extracted from the training data storage unit 20 to the probabilistic inference model.

Thereafter, the learning device 1 inputs the probabilistic inference result to the formatter. In FIG. 3, the probabilistic inference result represents the heat map of the six feature points to be extracted. Then, the formatter formats the probabilistic inference result so as to be a format suitable for the input to the correction learning model, and inputs the formatted probabilistic inference result (also referred to as “formatted inference result”) into the correction learning model.

Then, the learning device 1 trains the correction learning model based on the input image, the formatted inference result, and the correct answer data. In this case, for example, the learning device 1 performs training of the correction learning model based on: an inference result (also referred to as “corrected inference result”) outputted by the correction learning model when the input image and the formatted inference result are inputted to the correction learning model; and the correct answer data. In this case, the learning device 1 determines the parameters of the correction learning model so that the error (loss) between the corrected inference result and the correct answer data is minimized. The algorithm for determining parameters to minimize the loss may be any learning algorithm used in machine learning, such as a gradient descent method and an error back propagation method. It is noted that the output format of the probabilistic inference model (i.e., the already-trained model) need not be the same as the output format of the correction learning model.

A description will be given of a specific example of the application of the dropout to already-trained model.

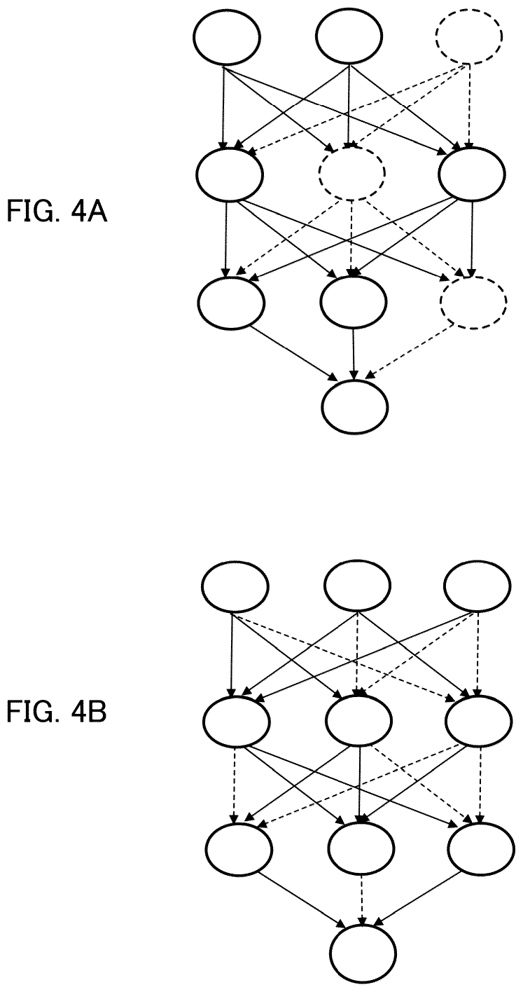

FIG. 4A shows a first specific example in which the dropout is applied to the already-trained model that is a neural network. FIG. 4B shows a second specific example in which the dropout is applied to the already-trained model. For convenience of explanation, the already-trained model shown in FIG. 4A and FIG. 4B is represented by a simple neural network. Also, nodes and edges excluded by dropout are indicated by dashed line.

In the example shown in FIG. 4A, the learning device 1 probabilistically (i.e., randomly according to a predetermined probability) selects a node from the nodes constituting the already-trained model and removes the selected node (that is, sets the weight parameter for edge(s) connected to the selected node to 0). On the other hand, in the example shown in FIG. 4B, an edge is probabilistically selected from the edges constituting the already-trained model, and the selected edge is removed (that is, the weight parameter for the edge is set to 0). In both cases of the first specific example and the second specific example, the learning device 1 suitably builds a probabilistic inference model in which the already-trained model is operated so as to output a probabilistically-generated inference result.

In this way, the learning device 1 applies the dropout, which is usually used in the learning stage to prevent over-learning, to the already-trained model in the inference stage. This makes it possible to obtain inference results that include errors due to variations of inputs that are prone to errors without analyzing the tendency of errors, such as PoseFix, which is an inference method using a learning model that corrects the inference results. In addition, in this case, the high-order correlation of the error is automatically reflected.

(3-2) Functional Blocks

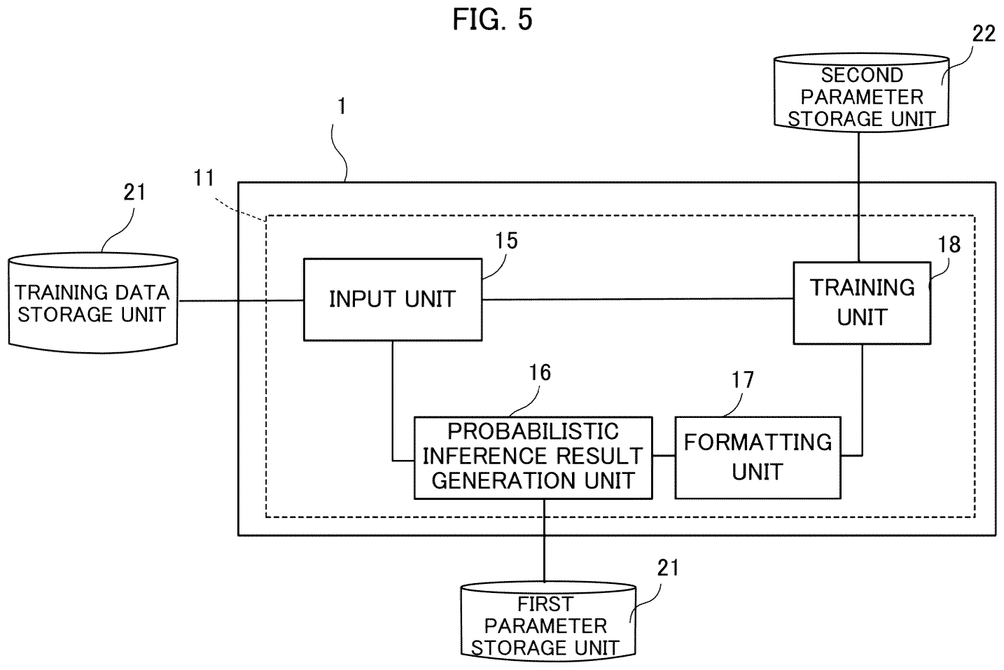

FIG. 5 is an example of a functional block diagram of the learning device 1 relating to the learning process in the first example embodiment. As shown in FIG. 5, the processor 11 of the learning device 1 functionally includes an input unit 15, a probabilistic inference result generation unit 16, a formatting unit 17, and a training unit 18. In FIG. 5, blocks for transmitting and receiving data are connected by a solid line, but the combination of blocks for transmitting and receiving data is not limited to FIG. 5. The same applies to the drawings of other functional blocks described below.

The input unit 15 acquires a set of the input image and the correct answer data from the training data storage unit 20 via the interface 13. The input unit 15 performs data augmentation when the set of the input image and the correct answer data extracted from the training data storage unit 20 is the data already used for training the already-trained model. In this case, the input unit 15 performs image conversion such as color adjustment, cropping, and inversion operation on the input image extracted from the training data storage unit 20, and converts the correct answer data in accordance with the conversion of the corresponding input image. Thereby, the input unit 15 acquires a set of the input image and the correct answer data to be used in the present learning stage. The input unit 15 may perform augmentation for the set of the input image and the correct answer data that are not used for training the already-trained model, and increase the amount of data of the training data. The input unit 15 supplies the input image to be used for training to the probabilistic inference result generation unit 16 and the training unit 18, and supplies correct answer data corresponding to the input image to the training unit 18.

The probabilistic inference result generation unit 16 generates a probabilistic inference result based on the input image supplied from the input unit 15. In this case, the probabilistic inference result generation unit 16 builds an already-trained model based on the parameters stored in the first parameter storage unit 21, and further builds a probabilistic inference model that is the already-trained model to which a probabilistic parameter operation is applied. Then, the probabilistic inference result generation unit 16 generates a probabilistic inference result by inputting the input image to the probabilistic inference model.

The formatting unit 17 performs a predetermined formatting process on the probabilistic inference result generated by the probabilistic inference result generation unit 16 to thereby generate a formatted inference result conforming to the input format of the correction learning model. In this case, the probabilistic inference result may be a heat map, may be a segmentation result for the input image, may be a classification result for the input image, or may be a detection result of a predetermined object. For example, when the probabilistic inference result indicates the classification result for the input image, the formatting unit 17 generates the formatted inference result representing a predetermined number (e.g., the top three) of classes having the highest likelihoods. In addition, when the probabilistic inference result is the inference result of the feature points, the formatting unit 17 can change (consolidate) the feature point labels so as to to be unique to each feature point. A specific example of the consolidation of the feature point labels will be described in detail in the second example embodiment.

The training unit 18 trains the correction learning model on the basis of the formatted inference result generated by the formatting unit 17 and the input image and correct answer data supplied from the input unit 15, and stores parameters of the correction learning model obtained through the training in the second parameter storage unit 22.

Here, each component of the input unit 15, the probabilistic inference result generation unit 16, the formatting unit 17, and the training unit 18 can be realized, for example, by the processor 11 executing a program. The necessary programs may be recorded on any non-volatile storage medium and installed as necessary to realize each component. It should be noted that at least a portion of these components may be implemented by any combination of hardware, firmware, and software, or the like, without being limited to being implemented by software based on a program. At least some of these components may also be implemented using user programmable integrated circuit such as FPGA (Field-Programmable Gate Array) and microcontrollers. In this case, an integrated circuit may be used to realize a program to function as each of the above components. Further, at least a part of the components may be constituted by an ASSP (Application Specific Standard Produce), an ASIC (Application Specific Integrated Circuit) or a quantum processor (quantum computer control chip). Thus, each of the above-described components may be realized by various hardware. The above explanation is true in other example embodiments described later. Furthermore, each of these components may be implemented by the cooperation of a plurality of computers, for example, using cloud computing technology.

(3-3) Input Format of Correction Learning Model

The formatted inference result supplied by the formatting unit 17 may be inputted to the input layer of the correction learning model together with the input image supplied by the input unit 15, or may be inputted to the intermediate layer of the correction learning model.

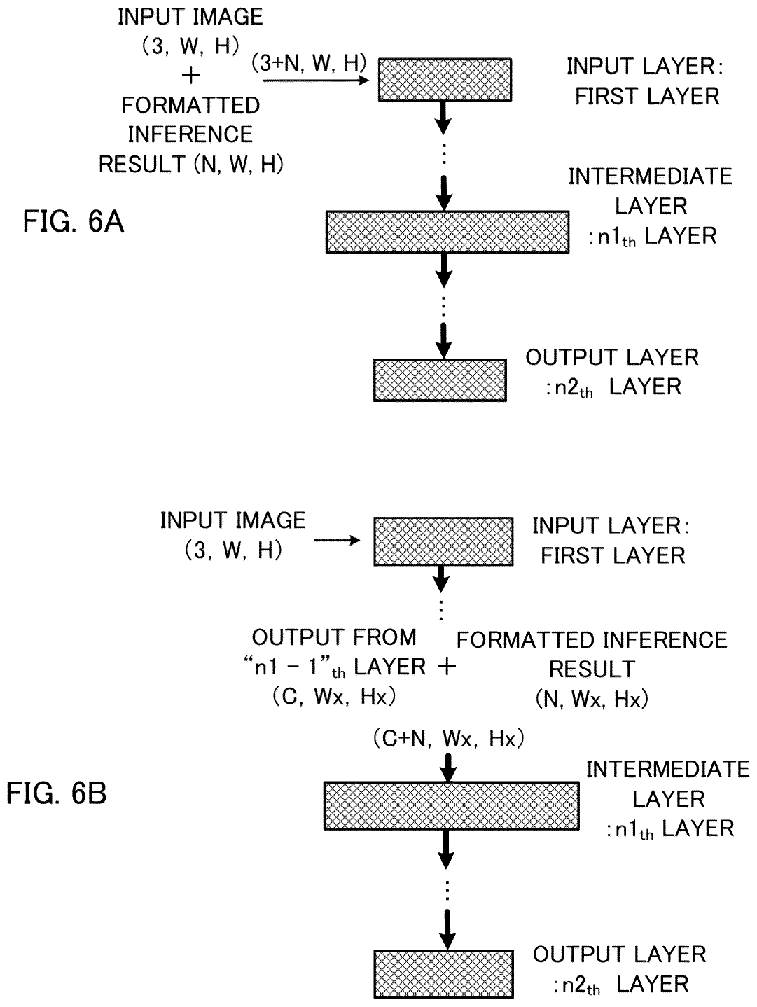

FIGS. 6A and 6B each shows a structure of a correction learning model with a clear indication of layer(s) thereof to which an input image supplied from the input unit 15 and a formatted inference result supplied from the formatting unit 17 are inputted. In FIG. 6A and FIG. 6B, the correction learning model is a neural network in which the number of the layers is “n2” (n2 is an integer of 3 or more) and which includes one or more intermediate layers including the “n1ₜₕ” layer (n1 is an integer of less than n2”). Here, the input layer is the first layer and the output layer is the n2ₜₕ layer.

In FIG. 6A, the input image and the formatted inference result are inputted to the input layer that is the first layer, respectively. On the other hand, in FIG. 6B, the input image is inputted to the input layer that is the first layer, and the formatted inference result is inputted to the intermediate layer that is the n1ₜₕ layer. In the example shown in FIG. 3, the formatted inference result is a heat map for each feature point to be extracted, and is inputted to the intermediate layer according to FIG. 6B. Thus, the formatted inference result may be inputted to the input layer of the correction learning model together with the input image supplied by the input unit 15, as shown in FIG. 6A, or may be inputted to the intermediate layer of the correction learning model, as shown in FIG. 6B.

Next, a description in more detail will be given of the data format at the time of input of the input image and the formatted inference result. In general, when entering two different pieces of information together, they need to be formatted in a tensor format. Therefore, the tensor data format used as an input format to the correction learning model will be specifically described below.

First, regarding the example shown in FIG. 6A, a description will be given of such a case that the input image that is a RGB color image and the formatted inference result that is the reliability map (heat map) for each feature point are inputted. It is herein assumed that the vertical and horizontal sizes of the input image are “W” and “H”, respectively. Since the pixels of the input image have RGB information, the input image has a three-dimensional tensor data format with sizes (3, W, H). On the other hand, since the formatted inference result indicates a confidence map of the presence of each feature point, data in a tensor data format (N, W, H) is obtained, wherein “N” denotes the number of feature points. Therefore, in the case shown in FIG. 6A, data in a tensor data format (3+N, W, H) in which both inputs of the input image and the formatted inference result are combined is inputted to the input layer that is the first layer.

Next, a description will be given of the example shown in FIG. 6B. In this case, the input image inputted to the input layer is converted, through the network prior to the n1ₜₕ layer, into data whose vertical and horizontal sizes are respectively “Wx” and “Hx” and channel size corresponding to the RGB direction is “C”. In this case, the tensor data format entered into the intermediate layer which is the n1ₜₕ layer is (C, Wx, Hx). Strictly speaking, it is not necessary to convert them into a three-dimensional tensor, and it may be converted into any dimensional tensor. The formatted inference result is also formatted by the formatting unit 17 so as to be a heat map in which the vertical and horizontal dimensions become “Wx” and “Hx”, respectively. Therefore, data in the three-dimensional tensor format (C+N, Wx, Hx) obtained by combining these two tensors is inputted to the intermediate layer that is the n1ₜₕ layer.

In an example in which the already-trained model is a network that outputs the above-described heat map, since the format of the input image is similar to the format of the probabilistic inference result, input data to the correction learning model is generated relatively easily, and training of the correction learning model is possible. This tendency is also true in dealing with an image segmentation problem or an object detection problem, although it also depends on the learning method to be applied to the correction learning model.

On the other hand, when dealing with image classification problems, the format is different between the input (input image) and the output (likelihood of each possible class) to the already-trained model. Therefore, in this case, the formatting unit 17 needs to convert the probabilistic inference result into the same format as the input image in the case shown in FIG. 6A whereas it generates the formatted inference result that is the probabilistic inference result converted into the same format as the output format of the “n1−1”ₜₕ layer of the correction learning model in the case shown in FIG. 6B.

For example, a description will be given of such a case that the formatted inference result is inputted to the intermediate layer that is the n1ₜₕ layer of the correction learning model according to FIG. 6B in the classification (identification) problem among “dog, cat, bird”. Here, for example, if there is obtained a probabilistic inference result indicating that the likelihood of each class is “0.6” for dog, “0.3” for cat, or “0.1” for bird, the formatting unit 17 generates tensors in such a format (Wx, Hx) that elements indicate the same value for each class (dog, cat, and bird), respectively. Then, the formatting unit 17 combines the data in the format (3, Wx, Hx) whose elements are “0.6”, “0.3”, and “0.1” in the channel direction with the converted input data in the format (C, Wx, Hx) and inputs the combined data in the format (C+3, Wx, Hx) to the intermediate layer that is the n1ₜₕ layer. Since the dimension of the tensor can also be changed through the network prior to the “n1−1”ₜₕ layer, the formatting unit 17 does not necessarily need to generate the formatted inference result in the format (C, Wx, Hx).

In this way, the formatting unit 17 converts the probabilistic inference result into a required data format. Accordingly, even when the data format of the probabilistic inference result varies depending on the inference description, it is possible to perform training of the correction learning model that can cope with any inference problem. The processing to be executed by the formatting unit 17 is determined in advance according to, for example, the data format of the probabilistic inference result, and information necessary for the execution of the processing is stored in advance in the memory 12 or the storage device 2.

(4) Process Flow

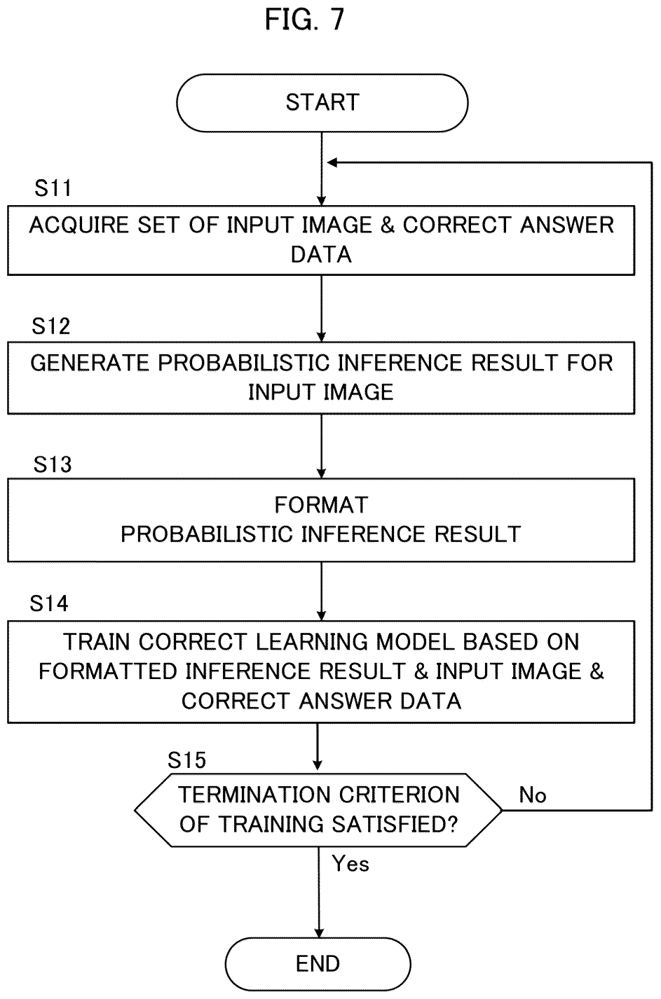

FIG. 7 is an example of a flowchart illustrating a procedure of a learning process that is executed by the learning device 1.

First, the input unit 15 of the learning device 1 acquires an input image and its correct answer data to be used for training (step S11). Here, if the set of the input image and the correct answer data stored in the training data storage unit 20 is the data used for the training of the already-trained model, the input unit 15 performs data augmentation that is not performed in the training of the already-trained model. In this case, the input unit 15 executes a predetermined image conversion for the input image, and converts the correct answer data in accordance with the conversion of the input image. The input unit 15 may perform data augmentation in the same manner to increase the amount of the training data even if the acquired set of the input image and the correct answer data is not used for training the already-trained model.

Next, the probabilistic inference result generation unit 16 of the learning device 1 generates the probabilistic inference result for the input image acquired at step S11 (step S12). In this case, the probabilistic inference result generation unit 16 acquires the probabilistic inference result by building the probabilistic inference model that is the already-trained model to which the dropout is applied and inputting the input image into the probabilistic inference model, wherein the already-trained model is built with reference to the first parameter storage unit 21. Then, the formatting unit 17 of the learning device 1 formats the probabilistic inference result in a format suitable for inputting the correction learning model (step S13). Thereby, the formatting unit 17 generates a formatted inference result.

Then, the training unit 18 of the learning device 1 trains the correction learning model based on the formatted inference result generated at step S13 and the input image and correct answer data acquired at step S11 (step S14). In this case, the training unit 18 determines the parameters of the correction learning model such that the loss between the corrected inference result and the correct answer data obtained by inputting the formatted inference result and the input image into the correction learning model is minimized, and stores the determined latest parameters of the correction learning model in the second parameter storage unit 22.

Next, the learning device 1 determines whether or not the termination criterion of training is satisfied (step S15). The learning device 1 may make the termination determination of the learning at step S15, for example, by determining whether or not the loop count has reached a predetermined loop count set in advance, or by determining whether or not the training has been performed for a preset number of training data. In another example, the learning device 1 may make the termination determination of the training at step S15 by determining whether or not the loss has fallen below a preset threshold value, or may make the determination by determining whether or not the variation in the loss has fallen below a preset threshold value. It is noted that the termination determination of the training at step S15 may be a combination of the above-described examples, or may be made according to any other determination method.

If the termination criterion of the learning is satisfied (step S15; Yes), the learning device 1 ends the process of the flowchart. On the other hand, if the termination criterion of the learning is not satisfied (step S15; No), the learning device 1 gets back to the process at step S11. In this instance, the learning device 1 acquires an input image and correct answer data which are not used yet at step S11.

According to the flowchart shown in FIG. 7, it is possible to suitably train a correction learning model to accurately correct the inference result outputted from the already-trained model.

Here, a supplementary description will be given of the inference using the correction learning model. In the inference stage, a target image of the inference is inputted to the already-trained model, and the inference result outputted by the already-trained model is formatted by the same process as in the formatting unit 17 and is converted into the formatted inference result. After that, by inputting the target image of the inference and the formatted inference result into the correction learning model, the corrected inference result in which the inference result outputted by the already-trained model is suitably corrected can be obtained. The process in the inference stage may be performed by any device other than the learning device 1. In this case, the device performs the process described above with reference to the learned parameters of the already-trained model and the correction learning model.

Next, a supplementary description will be given of the difference from the above-described PoseFix for the model learning to correct the inference result. In PoseFix, it is assumed that the tendency of errors is simple, and it is applied only when the reason for the present degradation of accuracy is obvious, such as specializing in occlusion issues. Besides, in PoseFix, the appropriate analysis is required for the grasp of the statistical error tendency. For example, when blurring of feature points is not isotropic (such as up, down, left, and right), or when a quadratic or higher correlation (such as poor accuracy of b if there is no a) appears remarkably, advanced analysis is required to reflect them. In contrast, in the present example embodiment, it is possible to suitably generate data necessary for training of a correction learning model without requiring analysis of statistical error tendency or the like and to perform training of the correction learning model. Further, in the present example embodiment, when a certain data augmentation is not performed in the training of the already-trained model, the certain data augmentation may be performed at the time of training the correction learning model for data reinforcement.

(5) Modifications

Instead of the input image, data in any format, such as video and audio data, other than an image may be inputted to the already-trained model and the correction learning model.

Generally, deep neural networks used for the already-trained model and correction learning model can be applied not only to image recognition but also to video recognition (scene classification and identification of important scenes), speech recognition, and natural language processing. Then, the difference (sometimes no difference) in processing between the data to be used in the above-mentioned cases and the image is the dimension of the inputted tensor. For is example, in the case of images, the three-dimensional tensor with RGB and vertical and horizontal directions (see the section “(3-3) Input Format of Correction Learning Model”) is used, and in the case of videos, the four-dimensional tensor obtained by adding the time direction to the above-mentioned three-dimensional tensor is used. Then, for these data, as shown in FIGS. 6A and 6B, the formatter 17 formats the outcome of the probabilistic inference result generation unit 16 to suitably conform to input layer of the correction learning model or to be suitably combined with the output format of the intermediate layer that is the (n1−1)ₜₕ layer. For example, in the video recognition, the formatting unit 17 formats the probabilistic inference result about the scene classification or important scenes so that it can be inputted to the input layer of the correction learning model or the intermediate layer which is the n1ₜₕ layer. As described above, the learning device 1 can suitably train the correction learning model that corrects the inference result outputted by the already-trained model to which the data in a format other than the image is to be inputted.

### Second Example Embodiment

The second example embodiment is an application example of the first example embodiment related to feature point extraction for an object (structure) having a point symmetry such as a sports venue. Examples of the object (structure) include a field of various kind of sports such as tennis, swimming, soccer, table-tennis, basketball, and rugby, a field of various kind of game such as shogi and go, a stage of a theatre, and a model of a sport field. In the second example embodiment, by making the definition of the labels of the feature points to be used by the already-trained model different from the definition of the labels of the feature points to be used by the correction learning model, and by using the image obtained by reversing the input image, the enhancement of the training data is suitably realized.

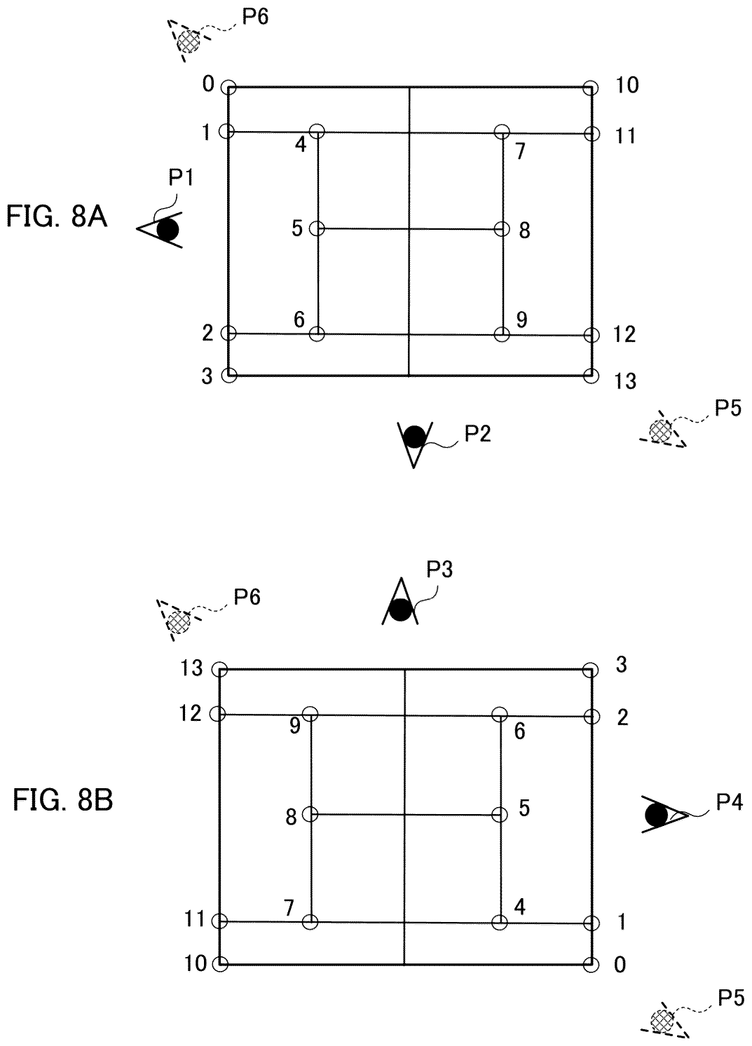

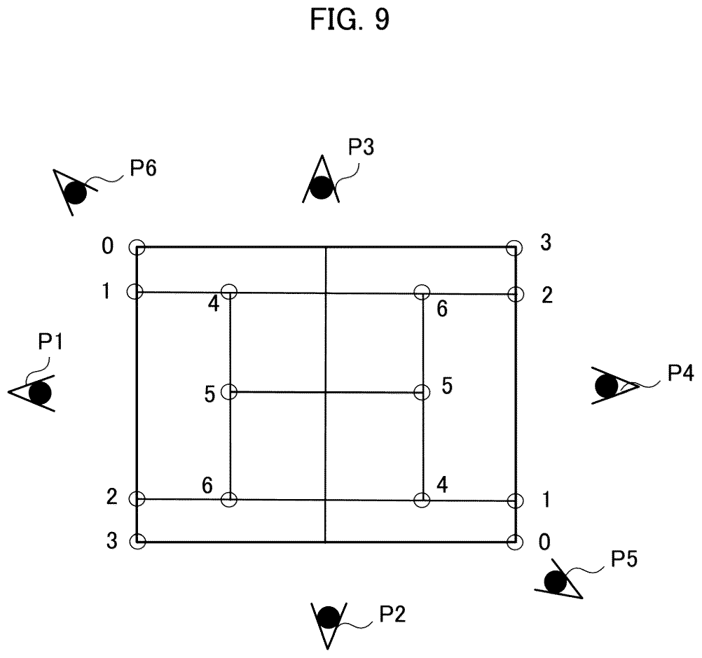

Here, a description will be given of separate name definition separately (differently) defining the labels of the feature points in the symmetry relation, and same name definition defining the labels of the feature points in the symmetry relation with the same name. FIGS. 8A and 8B each shows the label (0 to 13) of each feature point when thirteen feature points of a tennis court are labeled by separate name definition. FIG. 9 shows the label (0 to 6) of each feature point when thirteen feature points of a tennis court are labeled by same name definition. Here, FIG. 8A shows the label of each feature point when observed from the viewpoint position “P1” and the viewpoint position “P2”, and FIG. 8B shows the label of each feature point when observed from the viewpoint position “P3” and the viewpoint position “P4”.

As shown in FIGS. 8A and 8B, in the case of the separate name definition, the label definition depends on the observing direction. Therefore, in the viewpoint position “P5” and the viewpoint position “P6” situated in the boundary, the definition becomes ambiguous. Thus, in the extraction of the feature points whose labels are defined by separate name definition, there exists an angle of view that is difficult to extract the feature points, but in other angles of view, the extraction of the feature points with high accuracy is performed. In addition, when the image is reversed (reversed), it is difficult to redefine the labels because of the ambiguity of the boundary, and grasping the error tendency also becomes difficult. Therefore, in the separate name definition, the use of a reversed image as an input requires additional ruling in the generation of the corresponding correct answer data.

On the other hand, as shown in FIG. 9, in the case of the same name definition, while the labels of the respective feature points are determined in all viewpoint position P1 to viewpoint position P6 without depending on the viewing position, two feature point that differ in appearance need to be inferred as the same one. Therefore, in general, the overall accuracy tends to decrease as compared to the extraction of feature points whose labels are defined by separate name definition. It is noted that, in the case of the same name definition, the definition of the labels is determined regardless of the angle of view even if the image is reversed.

Accordingly, in the second example embodiment, the learning device 1 uses the separate name definition in the already-trained model and the same name definition in the correction learning model. Thereby, in the present example embodiment, while taking the advantage of the separate name definition, it is possible to eliminate the disadvantage of the separate name definition.

Specifically, as a first advantage, since the labels of the feature points can be determined in the case of the same name definition even when the image is reversed (i.e., the correct answer data can be automatically generated), the learning device 1 can suitably use, for the training of the correction learning model, the reversed image of the input image that was used for the training of the already-trained model. In other words, augmentation of training data can be suitably performed by applying augmentation, which is difficult to apply when learning stage of the already-trained model, to the training of the correction learning model.

As a second advantage, the learning device 1 can train the correction learning model that suitably corrects the error of the inference result at the angle of view that is difficult to identify feature points when the separate name definition is used. As a third advantage, since the learning device 1 also uses, as an input, the result at the angle of view in which high accuracy results can be obtained by separate name definition, it is possible to train the correction learning model especially in such an angle of view that is difficult to identify feature points. The statistical analysis used in PoseFix is also difficult to analyze the tendency on the same name definition when the reverse operation is performed (that is, information other than the feature point position information is also required), but the tendency is automatically reflected when the dropout is used as in the present example embodiment.

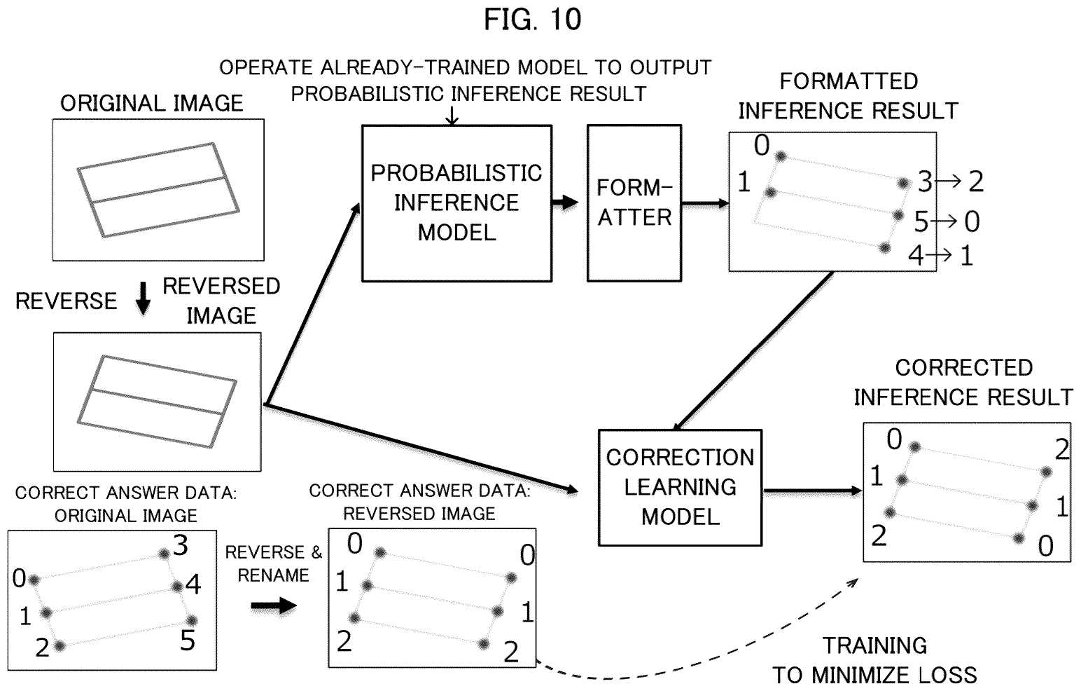

FIG. 10 is a schematic diagram of the process according to the second example embodiment. FIG. 10 shows an outline of the process in which training of the already-trained model is performed based on the input image stored in the training data storage unit 20 and then training of the correction learning model is performed based on the image obtained by reversing the input image stored in the training data storage unit 20. Hereafter, the input image stored in the training data storage unit 20 is simply referred to as “original image”, and the image obtained by reversing the original image is simply referred to as “reversed image”.

In this case, the input unit 15 first generates a reversed image obtained by reversing the original image and also performs conversion (renaming) of the labels based on the reverse and a predetermined rule for the correct answer data of the original image. The rule of renaming is predetermined according to the arrangement of the feature points and the definition of the labels of the feature points, and in the example shown in FIG. 10, the rule is as follows.
replace label 0 with label 2
change label 3 to label 0
change label 4 to label 1
change label 5 to label 2

Thereafter, the probabilistic inference result generation unit 16 inputs the reversed image to the probabilistic inference result generated by applying the dropout to the already-trained model, and the formatting unit 17 formats the probabilistic inference result using the formatter. In addition, the formatting unit 17 renames the labels so that the respective feature points included in the probabilistic inference result are labeled according to the same name definition. Specifically, on the basis of the correspondence relation between the same name definition and the separate name definition, the formatting unit 17 generates the formatted inference result, to which the following label conversion is applied, so that paired feature points existing at the symmetric positions have the same label.
change label 3 to label 2
change label 4 to label 1
change label 5 to label 0

Next, the training unit 18 trains the correction learning model on the basis of the reversed image, the correct answer data of the reversed image, and the formatted inference result. In this case, the training unit 18 updates the parameters of the correction learning model such that the loss between the corrected inference result obtained by inputting the reversed image and the formatted inference result into the correction learning model and the correct answer data of the reversed image is minimized.

In the explanation regarding FIG. 10, the process executed by the input unit 15 corresponds to the process at step S11 in FIG. 7, the process executed by the probabilistic inference result generation unit 16 corresponds to the process at step S12, the process executed by the formatting unit 17 corresponds to the process at step S13, and the process executed by the training unit 18 corresponds to the process at step S14. Thus, even in the second example embodiment, within the framework of the process represented by the flowchart shown in FIG. 7, the learning device 1 can suitably train the correction learning model based on the reversed image.

### Third Example Embodiment

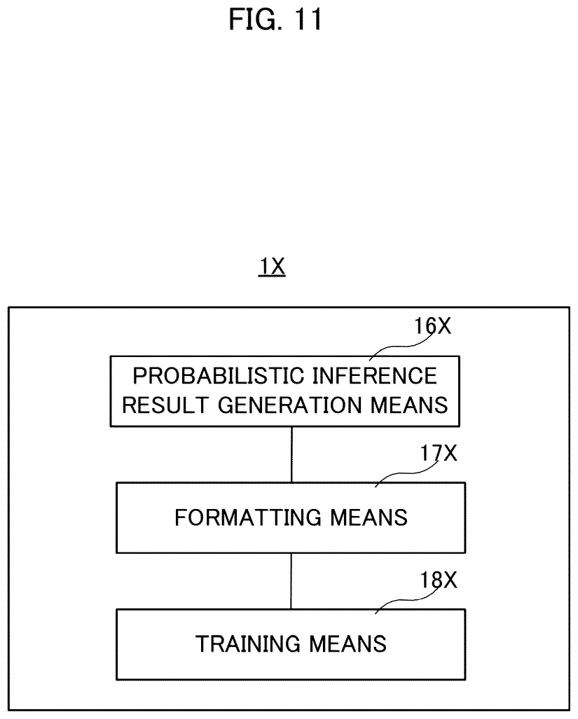

FIG. 11 is a block diagram illustrating a learning device 1X according to the third example embodiment. As shown in FIG. 11, the learning device 1X includes a probabilistic inference result generation means 16X, a formatting means 17X, and a training means 18X.

The probabilistic inference result generation means 16X is configured to generate a probabilistic inference result that is probabilistically generated for an input data. Examples of the input data include an image, a moving image (video), audio data, and text data. The inference result herein indicates any inference result for the above-mentioned data. The input data is not limited to data prepared as training data, and may be data generated by applying data augmentation to the data. Examples of the probabilistic inference result generation means 16X herein include the probabilistic inference result generation unit 16 according to the first example embodiment (including modifications, the same applies hereinafter) and the second example embodiment.

The formatting means 17X is configured to generate a formatted inference result obtained by formatting the probabilistic inference result. Examples of the formatting means 17X include the formatting unit 17 according to the first example embodiment and the second example embodiment.

The training means 18X is configured to train a correction learning model that is a learning model configured to correct the formatted inference result, based on the input data, correct answer data corresponding to the input data, and the formatted inference result. Examples of the training means 18X include the training unit 18 according to the first example embodiment or the second example embodiment.

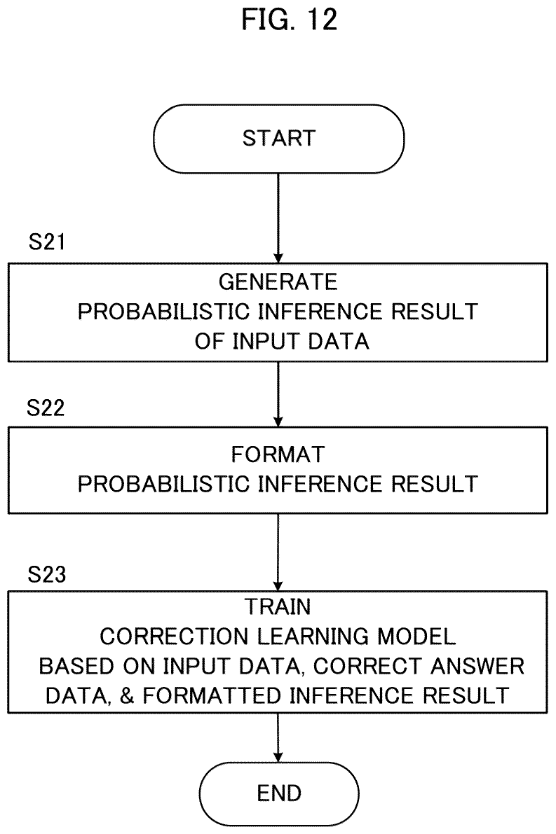

FIG. 12 is an example of the flowchart to be executed by the learning device 1X according to the third example embodiment. First, the probabilistic inference result generation means 16X generates a probabilistic inference result that is probabilistically generated for an input data (step S21). Next, the formatting means 17X is configured to generate a formatted inference result is obtained by formatting the probabilistic inference result (step S22). The training means 18X trains a correction learning model that is a learning model configured to correct the formatted inference result, based on the input data, correct answer data corresponding to the input data, and the formatted inference result (step S23).

According to the third example embodiment, the learning device 1X can suitably train a correction learning model that correct the inference result of the input data.

The whole or a part of the example embodiments (including modifications, the same shall apply hereinafter) described above can be described as, but not limited to, the following Supplementary Notes.

[Supplementary Note 1]

A learning device comprising:
a probabilistic inference result generation means configured to generate a probabilistic inference result that is probabilistically generated for an input data;
a formatting means configured to generate a formatted inference result obtained by formatting the probabilistic inference result; and
a training means configured to train a correction learning model that is a learning model configured to correct the formatted inference result, based on the input data, correct answer data corresponding to the input data, and the formatted inference result.

[Supplementary Note 2]

The learning device according to Supplementary Note 1,
wherein the probabilistic inference result generation means is configured to generate the probabilistic inference result based on a probabilistic inference model that is a model obtained by probabilistically changing one or more parameters of an already-trained model whose inference result is to be corrected by the correction learning model.

[Supplementary Note 3]

The learning device according to Supplementary Note 2,
wherein the already-trained model is a model based on a neural network, and
wherein the probabilistic inference result generation means is configured to generate the probabilistic inference result based on the probabilistic inference model that is a model obtained by probabilistically setting one or more weight parameters of the already-trained model to 0.

[Supplementary Note 4]

The learning device according to any one of Supplementary Notes 1 to 3,
wherein the formatted inference result is inputted, together with the input data, to an input layer to which the input data is inputted, or
wherein the formatted inference result is inputted to an intermediate layer that is different from the input layer.

[Supplementary Note 5]

The learning device according to Supplementary Note 4,
wherein the formatting means is configured to format the probabilistic inference result into a data format necessary for input to the input layer or to the intermediate layer.

[Supplementary Note 6]

The learning device according to any one of Supplementary Notes 1 to 5, further comprising
an input means configured to apply, to data used for training of an already-trained model whose inference result is to be corrected by the correction learning model, an augmentation that is not used in the training, to thereby generate the input data and the correct answer data corresponding to the input data.

[Supplementary Note 7]

The learning device according to any one of Supplementary Notes 1 to 6,
wherein the already-trained model whose inference result is to be corrected by the correction learning model is trained with labels based on separate name definition in which feature points in a symmetrical relation are separately labeled, and
wherein the correction learning model is trained with labels based on same name definition in which the feature points in the symmetrical relation are labeled as a same label, and
wherein the formatting means is configured to generate the formatted inference result labeled based on the same name definition into which the probabilistic inference result labeled based on the separate name definition is converted.

[Supplementary Note 8]

The learning device according to Supplementary Note 7, further comprising
an input means configured
   to generate, as the input data, a reversed image obtained by reversing an image used for training the already-trained model which learned to extract feature points of an object having a symmetry shown in the image and
   to generate correct answer data corresponding to the reversed image from the correct answer data corresponding to the image,
wherein the training means is configured to train the correction learning model based on the formatted inference result, the reversed image, and the correct answer data corresponding to the reversed image.

[Supplementary Note 9]

A learning method executed by a computer, the learning method comprising:
generating a probabilistic inference result that is probabilistically generated for an input data;
generating a formatted inference result obtained by formatting the probabilistic inference result; and
training a correction learning model that is a learning model configured to correct the formatted inference result, based on the input data, correct answer data corresponding to the input data, and the formatted inference result.

[Supplementary Note 10]

A storage medium storing a program executed by a computer, the program causing the computer to:
generate a probabilistic inference result that is probabilistically generated for an input data;
generate a formatted inference result obtained by formatting the probabilistic inference result; and
train a correction learning model that is a learning model configured to correct the formatted inference result, based on the input data, correct answer data corresponding to the input data, and the formatted inference result.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF REFERENCE NUMERALS

1, 1X Learning device
2 Storage device
11 Processor
12 Memory
13 Interface
20 Training data storage unit
21 First parameter storage unit
22 Second parameter storage unit
100 Learning system

What is claimed is:

1. A learning device comprising:
at least one memory configured to store instructions; and
at least one processor configured to execute the instructions to:
generate a probabilistic inference result that is probabilistically generated for an input data;
generate a formatted inference result obtained by formatting the probabilistic inference result; and
train a correction learning model that is a learning model configured to correct the formatted inference result, based on the input data, correct answer data corresponding to the input data, and the formatted inference result.

2. The learning device according to claim 1,
wherein the at least one processor is configured to execute the instructions to generate the probabilistic inference result based on a probabilistic inference model that is a model obtained by probabilistically changing one or more parameters of an already-trained model whose inference result is to be corrected by the correction learning model.

3. The learning device according to claim 2,
wherein the already-trained model is a model based on a neural network, and
wherein the at least one processor is configured to execute the instructions to generate the probabilistic inference result based on the probabilistic inference model that is a model obtained by probabilistically setting one or more weight parameters of the already-trained model to 0.

4. The learning device according to claim 1,
wherein the formatted inference result is inputted, together with the input data, to an input layer to which the input data is inputted, or
wherein the formatted inference result is inputted to an intermediate layer that is different from the input layer.

5. The learning device according to claim 4,
wherein the at least one processor is configured to execute the instructions to format the probabilistic inference result into a data format necessary for input to the input layer or to the intermediate layer.

6. The learning device according to claim 1,
wherein the at least one processor is further configured to execute the instructions to apply, to data used for training of an already-trained model whose inference result is to be corrected by the correction learning model, an augmentation that is not used in the training, to thereby generate the input data and the correct answer data corresponding to the input data.

7. The learning device according to claim 1,
wherein the already-trained model whose inference result is to be corrected by the correction learning model is trained with labels based on separate name definition in which feature points in a symmetrical relation are separately labeled, and
wherein the correction learning model is trained with labels based on same name definition in which the feature points in the symmetrical relation are labeled as a same label, and
wherein the at least one processor is configured to execute the instructions to generate the formatted inference result labeled based on the same name definition into which the probabilistic inference result labeled based on the separate name definition is converted.

8. The learning device according to claim 7,
wherein the at least one processor is configured to execute the instructions
to generate, as the input data, a reversed image obtained by reversing an image used for training the already-trained model which learned to extract feature points of an object having a symmetry shown in the image and
to generate correct answer data corresponding to the reversed image from the correct answer data corresponding to the image,
wherein the at least one processor is configured to execute the instructions to train the correction learning model based on the formatted inference result, the reversed image, and the correct answer data corresponding to the reversed image.

9. A learning method executed by a computer, the learning method comprising:
generating a probabilistic inference result that is probabilistically generated for an input data;
generating a formatted inference result obtained by formatting the probabilistic inference result; and
training a correction learning model that is a learning model configured to correct the formatted inference result, based on the input data, correct answer data corresponding to the input data, and the formatted inference result.

10. A non-transitory computer readable storage medium storing a program executed by a computer, the program causing the computer to:
generate a probabilistic inference result that is probabilistically generated for an input data;
generate a formatted inference result obtained by formatting the probabilistic inference result; and
train a correction learning model that is a learning model configured to correct the formatted inference result, based on the input data, correct answer data corresponding to the input data, and the formatted inference result.
